(19) United States
(12) Patent Application Publication
(10) Pub. No.: US 2026/0288135 A1
(43) Pub. Date: Sep. 24, 2026

(54) DEVICE FOR CONTROLLING MICROMOBILITY ASSETS AND METHODS THEREOF

(71) Applicant: Joyride Technologies Inc., Toronto (CA)

(72) Inventors: Nishant Modi, Toronto (CA); Vincenzo Cifani, Etobicoke (CA)

(21) Appl. No.: 19/686,005

(22) Filed: May 22, 2026

Related U.S. Application Data
(63) Continuation of application No. PCT/CA2024/051562, filed on Nov. 22, 2024.

(30) Foreign Application Priority Data
Nov. 22, 2023 (GB) 2317863.5

(51) Int. Cl. G05D 1/226; G05D 1/248; G05D 1/698; G05D 109/10; G05D 111/30; H04W 4/021; H04W 4/40; H04W 4/80

(52) U.S. Cl. CPC G05D 1/226; G05D 1/248; G05D 1/6987; H04W 4/021; H04W 4/40; H04W 4/80; G05D 2109/13; G05D 2111/32

(57) ABSTRACT

A device may include a chassis having a mount for attachment to a frame of a micro-mobility. A device may include a board assembly within the chassis having: a memory for storing programming instructions, a processor in communication with the memory for executing the programming instructions, a first communication interface connected to the processor and for connection to an activation and management unit (AMU) of the micro-mobility, a second communication interface connected to the processor for communication with a remote computing device, the programming instructions for configuring the processor to: (a) determine a type of the micro-mobility and associated AMU, (b) based on the type, establish a range of instructions to the associated AMU for controlling the micro-mobility, (c) receive a control instruction from within the range of instructions from the remote computing device; and, (d) send the control instruction to the AMU to cause the micro-mobility to operate according to the instruction according to the type of the micro-mobility.

### CROSS REFERENCE TO RELATED APPLICATIONS

This application is a continuation of International Application No. PCT/CA2024/051562, filed Nov. 22, 2024, which claims priority from United Kingdom Patent Application No. 2317863.5, filed on Nov. 22, 2023, the entire contents of which are hereby incorporated by reference for all purposes.

### FIELD

The present specification relates generally to micro-mobility assets and more particularly to devices for controlling fleets of micro-mobility assets, such as vehicles.

### BACKGROUND

Micro-mobility assets have become a prominent solution in many urban and suburban environments, addressing the “last mile” problem that many commuters face daily. Micro-mobility assets include micro-mobility vehicles (cars, bikes, scooters, wheelchairs), industrial robots, drones, UAVs, and the like, etc. Micro-mobility vehicles include electric scooters, e-bikes, Electric scooters (e-scooters), Electric skateboards, bicycles, self-balancing scooters, shared pedal bikes, electric passenger vehicles such as golf carts, and other similar vehicles, offer a convenient way to cover short distances, bridging the gap between primary transportation hubs and final destinations.

Micro-mobility assets also provide new business models of mobility as a service, including e-hailing, real-time ridesharing, and other services of the sharing economy. When these assets are offered to users as a service, owners of the assets are typically responsible for maintenance of the assets, including charging the battery, fixing or replacing broken parts, and moving the asset to a central hub after a user has left it in an unknown location after use.

As such, it is beneficial to have methods and devices for controlling and/or managing fleets of micromobility assets.

### SUMMARY

An aspect of the specification provides a controller device for controlling a plurality of different types of micro-mobilities including: a chassis having a mount for attachment to a frame of a micro-mobility; a board assembly within the chassis having: a memory for storing programming instructions; a processor in communication with the memory for executing the programming instructions; a first communication interface connected to the processor and for connection to an activation and management unit (AMU) of the micro-mobility; and a second communication interface connected to the processor for communication with a remote computing device. In an embodiment, the processor can be configured to: (a) determine a type of the micro-mobility and associated AMU; (b) based on the type, establish a range of instructions to the associated AMU for controlling the micro-mobility; (c) receive a control instruction from within the range of instructions from the remote computing device; and, (d) send the control instruction to the AMU to cause the micro-mobility to operate according to the instruction according to the type of the micro-mobility.

In at least one embodiment, the controller can include at least one sensor connected to the plurality of micromobility vehicles for acquiring and transmitting data about the micromobility vehicle to the remote computing device; and wherein the data is at least one of: speed data, acceleration data, and location data.

In at least one embodiment, the at least one of the plurality of vehicles can transmit a broadcasted message to the remote computing device in an encrypted form.

In at least one embodiment, the at least another of the controllers of the plurality of vehicles decrypts the message to ascertain the broadcasted message.

In at least one embodiment, the remote computing device includes a positioning module for determining a location of the micromobility vehicle; and the programming instructions for further configuring the processor to: send an override control instruction to the AMU to cease movement of the micro-mobility if the location of the micromobility vehicle is outside of a geofenced area. In at least one embodiment, the remote computing device maintains a virtual map of the geo-fenced area.

In at least one embodiment, the remote computing device is configured to execute an application that can receive control instructions for a plurality of types of micromobility vehicles.

In at least one embodiment, the application is configured to authenticate with at least one micro-mobility fleet management engine that is respective to different micro-mobilities of the same or different types; and the application being further configured to accept control instructions for a given micro-mobility after authentication.

In at least one embodiment, the plurality of vehicles maintain continuous communication with each other by transmitting offline data over a Bluetooth low energy communication protocol; and wherein at least one of the plurality of vehicles is connected to the remote computing device such that the offline data from the plurality of vehicles is continuously received by the remote computing device via the controller device of the at least one of the plurality of vehicles.

An aspect of the specification provides a controller device further wherein the board assembly further or the remote computing device includes a location positioning module for determining a location the programming instructions for further configuring the processor to: send an override control instruction to the AMU to cease movement of the micro-mobility if the location is outside of a geo-fence.

An aspect of the specification provides a controller device further wherein the programming instructions for further configuring the processor to interact with an application on the remote computing device regardless of the type of the micro-mobility.

An aspect of the specification provides a controller device wherein remote computing device is configured to execute an application that can receive control instructions for each of the different types.

An aspect of the specification provides a controller device wherein the application is configured to authenticate with at least one micro-mobility fleet management engine that is respective to different micro-mobilities of the same or different types; the application being further configured to accept control instructions for a given micro-mobility only after authentication.

In an aspect, a method of controlling a plurality of micromobility vehicles using a controller is provided. In one embodiment, the method comprises: determining a type of the micro-mobility and associated AMU; based on the type, establishing a range of instructions to the associated AMU for controlling the micro-mobility; receiving a control instruction from within the range of instructions from the remote computing device; and, sending the control instruction to the AMU to cause the micro-mobility to operate according to the instruction according to the type of the micro-mobility.

In at least one embodiment, the method further comprises: acquiring and transmitting data from at least one sensor connected to the plurality of micromobility vehicles; and sending the data to the remote computing device; and wherein the data is at least one of: speed data, acceleration data, and location data.

In at least one embodiment, the method further comprises: transmitting, via the controller device, a broadcasted message to the remote computing device in an encrypted form.

In at least one embodiment, the method further comprises: decrypting, via at least another of the controllers of the plurality of vehicles, to ascertain the broadcasted message.

In at least one embodiment, the method further comprises: determining a location of the micromobility vehicle using a positioning module; and further configuring the processor to: send an override control instruction to the AMU to cease movement of the micro-mobility if the location of the micromobility vehicle is outside of a geofenced area.

In at least one embodiment, the method further comprises: maintaining a virtual map of the geo-fenced area on the remote computing device.

In at least one embodiment, the remote computing device is configured to execute an application that can receive control instructions for a plurality of types of micromobility vehicles.

In at least one embodiment, the application is configured to authenticate with at least one micro-mobility fleet management engine that is respective to different micro-mobilities of the same or different types; and the application being further configured to accept control instructions for a given micro-mobility after authentication.

In at least one embodiment, the method further comprises: maintaining continuous communication between the plurality of vehicles by transmitting offline data over a Bluetooth low energy communication protocol; and wherein at least one of the plurality of vehicles is connected to the remote computing device such that the offline data from the plurality of vehicles is continuously received by the remote computing device via the controller device of the at least one of the plurality of vehicles.

### BRIEF DESCRIPTION OF THE FIGURES

FIG. 1 illustrates a schematic diagram of a micromobility network.

FIG. 2 illustrates a block diagram of example internal components of the interference repository engine of FIG. 1.

FIG. 3 illustrates a flowchart depicting a method for controlling a micromobility asset.

FIG. 4 illustrates a block diagram of the IOT module and its connections to the micromobility asset and the server.

FIG. 5 illustrates a block diagram of the IOT module.

FIG. 6 illustrates a schematic diagram of the Bluetooth connectivity across a plurality of micromobility assets.

FIG. 7 illustrates a schematic diagram of the geofencing application.

FIG. 8 illustrates a schematic diagram of the geofencing application.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process de-scribed below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described here-in.

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Further-more, there is no intention to be bound by any expressed or implied theory presented in the pre-ceding technical field, background, brief summary or the following detailed description.

It should also be noted that the terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, an electrical signal, a light signal or a mechanical element depending on the particular context.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

Similarly, throughout this specification and the appended claims the term “communicative” as in “communicative pathway”, “communicative coupling”, and in variants such as “communicatively coupled” is generally used to refer to any engineered arrangement for transferring and/or ex-changing information. Examples of communicative pathways include, but are not limited to, electrically conductive pathways (e.g., electrically conductive wires, physiological signal conduction), electromagnetically radiative pathways (e.g., radio waves, optical signals, etc.), or any combination thereof. Examples of communicative couplings include, but are not limited to, electrical couplings, magnetic couplings, radio couplings, optical couplings or any combination there-of.

A portion of the example embodiments of the systems, devices, or methods described in accordance with the teachings herein may be implemented as a combination of hardware or soft-ware. For example, a portion of the embodiments described herein may be implemented, at least in part, by using one or more computer programs, executing on one or more programmable devices comprising at least one processing element, and at least one data storage element (including volatile and/or non-volatile memory). These devices may also have at least one input de-vice (e.g., a keyboard, a mouse, a touchscreen, an input pin, an input port and the like for providing at least one input such as an input signal, for example) and at least one output device (e.g., a display screen, a printer, a wireless radio, an output port, an output pin and the like for providing at least one output such as an output signal, for example) depending on the nature of the device.

It should also be noted that there may be some elements that are used to implement at least part of the embodiments described herein that may be implemented via software that is written in a high-level procedural language such as object-oriented programming. The program code may be written in C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments de-scribed herein may be stored on a storage media or a device that is readable by a general or special purpose programmable device. The software program code, when read by the programmable device, which may also be referred to as a computing device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, memory chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Any module, unit, component, server, computer, terminal or computing device described herein that executes software instructions in accordance with the teachings herein may include or otherwise have access to computer readable media such as storage media, computer storage media, or data storage devices (removable and/or non-removable) such as, for example, magnetic disks, optical disks, or tape. Computer storage media may include volatile and non-volatile, re-movable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

The various embodiments disclosed herein relate to systems, and methods for controlling and/or managing a plurality of micromobility assets, using a universal micromobility controller. The controller can also be referred to as a universal controller, controlling device, controller device, or simply ‘controller”.

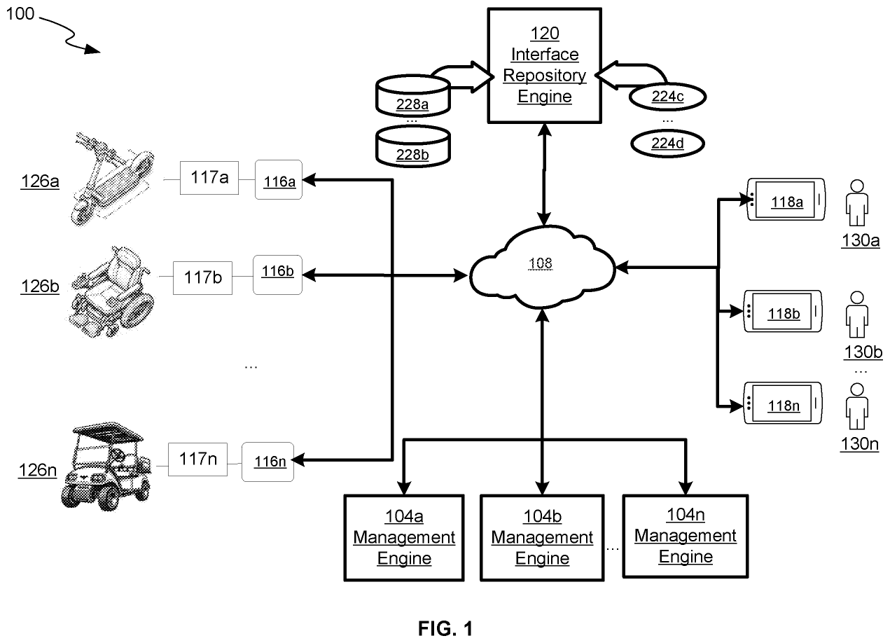

Turning now to the figures, FIG. 1 shows a micromobility network 100. The micro-mobility network 100 comprises a plurality of micromobility assets 126a, 126b . . . , 126n. The micromobility assets can also be referred to as electric mobility devices. In the embodiment shown in FIG. 1, the micromobility network 100 shows an electric scooter 126a, an electric wheelchair 126b and an electric golf cart 126n. In other embodiments, other types of micro-mobilities can be connected to the network. The other types of micro-mobility assets can include, but are not limited to electric or otherwise powered, including electric scooters (e-scooters), electric bicycles (e-bikes), electric skateboards, electric hoverboards, electric unicycles, electric roller skates, Segways™, kick scooters, shared bicycle systems, low speed vehicles golf-carts, personnel carriers, electric shopping carts, drones, automobiles, and the like. In some embodiment, the micromobility assets can be low speed and/or electric. In at least one embodiment, the micro-mobility assets 126 each include activation and management unit (AMU), shown by 117a to 117n. The AMU can be primitive and simply control whether the vehicle is “off or on”, such as an electronic key or equivalent. In other embodiments, the AMU can be more sophisticated and include an electronic control unit (ECU) that controls more than vehicle access, but can also control speed, battery, traction, stability or other.

The Engine Control Unit (ECU) of an electric mobility device, such as an e-bike or e-scooter, is an electronic control system configured to manage and regulate the operation of various electrical and mechanical subsystems of the device. The ECU typically includes a microcontroller, memory, and communication interfaces, and is operatively connected to sensors, actuators, and the battery management system (BMS). The ECU can also include a processor that can be configured to process signals from sensors such as throttle position sensors, pedal cadence sensors, and wheel speed sensors, and to execute control algorithms to optimize motor performance and energy efficiency. For example, the ECU may dynamically adjust motor torque and power delivery based on the rider's input, terrain conditions, and battery charge level to provide a smooth and efficient riding experience. The ECU can also control the interaction between regenerative braking systems and the motor, ensuring effective energy recovery while maintaining braking performance. Additionally, the ECU may regulate auxiliary features such as lighting, display interfaces, and connectivity modules for real-time monitoring and diagnostics, thereby providing comprehensive management of the electric mobility device's functionality.

Each of the vehicle ECUs and/or AMUs 117 can be connected to a controller 116. The controller can be used to connect each of the electric mobility device to a network 108. Network 108 interconnects the plurality of universal controllers 116 to micro-mobility fleet management engines 104. The network 108 can also be used to connect the plurality of universal controllers 116 to a plurality of user computing devices 118. Furthermore, the network 108 can access an interface repository engine 120. As will be discussed further below, engine 120 can be used to maintain programming instructions which can actuate the ECU 117 via the network 108, and the controller 116.

Network 108 can encompass a variety of communication methods. For example, devices 118 may connect to controllers 116 through a wide area network, such as the Internet, enabling long-range connectivity across multiple devices. Alternatively, it is also contemplated that a single device 118 can establish a direct, peer-to-peer connection with a single controller 116 using communication protocols such as Bluetooth or Near Field Communication (NFC). In such cases, network 108 may be embodied as the peer-to-peer link itself, demonstrating its flexibility to support both wide area and localized, direct communication modes. Network 108 can also be one or more of these types of links, to thereby generally convey that controllers 116, device 118, engines 104 and engine 120 can each include communication hardware such as network interfaces that allow for one or more different types of communication links to be effected. For example, the types of links can include, but are not limited to wired, wireless, local area network, wide area network, Internet based, private networks or public networks. In other words, network 108 can represent various ways in which electronic communication is enabled amongst the various nodes in micromobility network 100. The micromobility network 100 thus contemplates that each universal controller 116 can be connected to different types of micro-mobility assets 126 to a management engine 104, user devices 118, and a repository engine 120, via the network 108.

The micro-mobility fleet management engines 104a, 104b . . . 104n (collectively, engine 104) can be based on any present or future electronic servers or computing architectures that, amongst other things, manage fleets of micro-mobilities 126. In a present example embodiment, engines 104 can be based on servers hosted by different fleet providers of micro-mobilities 126. Thus, for example electric scooter micro-mobility 126a may be provided by micro-mobility fleet management engine 104a; electric wheelchair micro-mobility 126b may be provided by micro-mobility fleet management engine 104b; an electric golf cart micro-mobility 126n may be provided by micro-mobility fleet management engine 104n. In an alternative embodiment, each engine 104 can manage a plurality of micro-mobility devices at a time.

Turning now to the Interface Repository Engine 120, this component may comprise any suitable electronic server or computing system architecture designed to store and manage a library of programming interfaces. These interfaces can be configured to be deployed onto various universal controllers 116. By loading a specific interface onto a controller 116, the controller is can be equipped to communicate with and control its associated micro-mobility device 126, ensuring seamless and customized operation tailored to the specific requirements of the device.

Each universal controllers 116 can include a chassis having a mount for attachment to a frame of its respective micro-mobility vehicle 126. In one embodiment, each universal controllers 116 includes a board assembly within the chassis having: a memory for storing programming instructions; a processor in communication with the memory for executing the programming instructions; a first communication interface connected to the processor and for connection to an activation and management unit (AMU) of the micro-mobility 126; a second communication interface connected to the processor for communication with one or more computing devices 118 via network 108.

Thus, each computing device 118 is, itself, associated with different users 130. As will be appreciated from these teachings, the controllers 116 can allow for a given user 130 operating their device 118 to avail themself of transport via a micromobility asset 126 respective to its universal controller 116.

The programming instructions on each universal controller 116 can configure the processor to: determine a type of the micromobility asset 126 and associated AMU; based on the type of micromobility asset, establish a range of instructions to the associated AMU for controlling the micro-mobility 116. In one embodiment, the range of instructions can be stored on the repository engine 120. The processor can be further configured to receive a control instruction from within the range of instructions from a given device 118; and, send the control instruction to the AMU to cause the micromobility asset 126 to operate according to the instruction according to the type of the micromobility asset 126.

In this manner, each user 130 can access an application from their device 118 and be given access to different micro-mobilities 126 via communications between the application and respective universal controller 116.

In one embodiment, the remote computing device can also be configured to execute an application that can receive control instructions for each of the different types of micromobility vehicles. The application can be configured to authenticate with at least one micromobility vehicle fleet management engine that is respective to different micro-mobilities of the same or different types; the application being further configured to accept control instructions for a given micromobility vehicle only after authentication.

The board assembly or the remote computing device can further include a location positioning module for determining a location the programming instructions for further configuring the processor to: send an override control instruction to the AMU to cease movement of the micromobility vehicle if the location is outside of a geo-fence. As such, geographical boundaries can be created and enforced without requiring a continuous internet connection. In at least one embodiment, a GPS (Global Positioning System), RFID (Radio-Frequency Identification), Wi-Fi, or cellular data system can be used to define virtual boundaries in the real world. These boundaries, often called geofences, can trigger predefined actions or alerts when a device or object enters or exits the designated area.

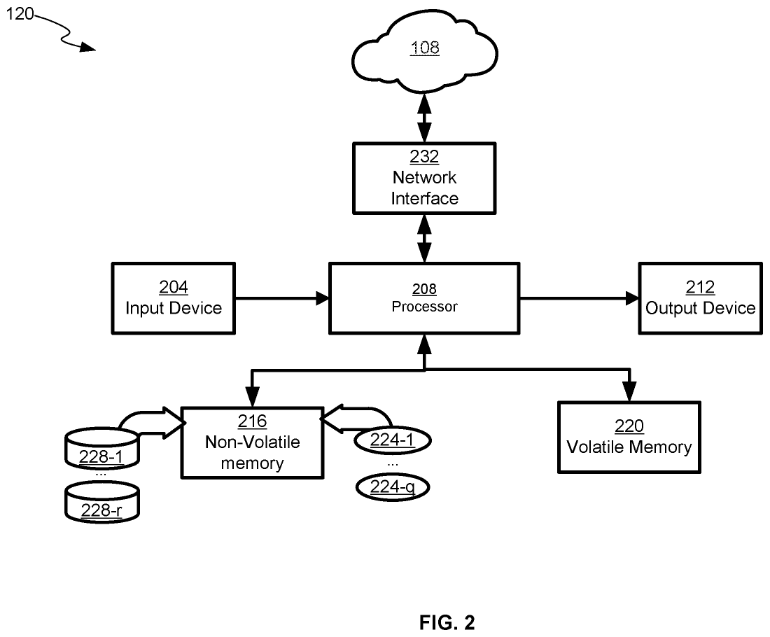

Having described an overview of micromobility network 100, it is useful to comment on the hardware infrastructure of micromobility network 100. FIG. 2 shows a schematic diagram of a non-limiting example of internal components of engine 120.

In this example, engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224. Thus, for example, databases 228 may maintain the libraries of programming instructions unique to each micromobility asset 126, such that those instructions can be downloaded onto universal controllers 116 and thereby fulfill the universality of each universal controllers 116, allowing a single type of universal controllers 116 to control different types of micromobility asset 126, and also allowing for one application to be deployed across computing devices 118 that can be used to allow access to different micro-mobilities 126.

Such an application can also be coordinated with different engines 104 to authenticate different users 130 and control access of individual users 130 to specific micro-mobilities 126. Payment processing functions can also be provided.

The infrastructure of engine 120, or a variant thereon, can be used to implement any of the computing nodes in micromobility network 100, including micro-mobility fleet management engines 104. Furthermore, engine 120 and micro-mobility fleet management engines 104 may also be implemented as virtual machines and/or with mirror images to provide load balancing. Functions of engine 120 may also be distributed amongst different micro-mobility fleet management engines 104 and/or platforms 114, thereby obviating the need for a central engine 120. By the same token, a plurality of engines 120 may be provided.

Furthermore, a person of skill in the art will recognize that the core elements of processor 208, input device 204, output device 212, non-volatile memory 216, volatile memory 220 and network interface 232, as described in relation to the server environment of engine 120, have analogues in the different form factors of client machines such as those that can be used to implement universal controllers 116 and computing devices 118.

Notably, however, universal controllers 116 can have common hardware include changeable programming instructions to allow the common hardware of each universal controllers 116 to control different micro-mobilities 126 according to programming instructions maintained on engine 120.

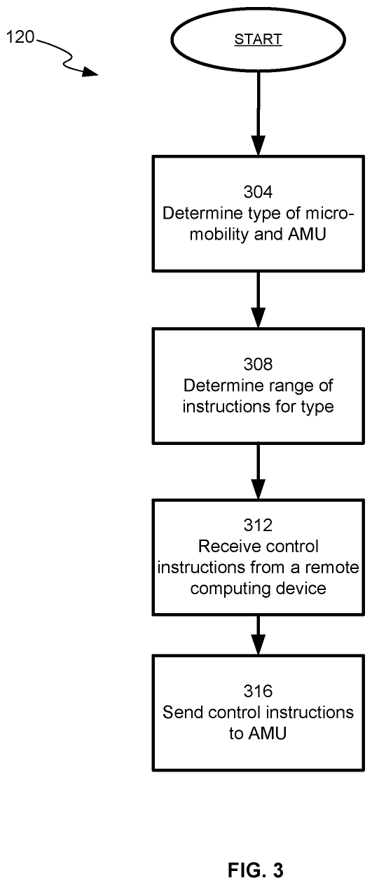

FIG. 3 shows a flowchart depicting a method for controlling a micro-mobility indicated generally at 300. Method 300 can be implemented on micromobility network 100. Persons skilled in the art may choose to implement method 300 on micromobility network 100 or variants thereon, or with certain blocks omitted, performed in parallel or in a different order than shown. Method 300 can thus also be varied. However, for purposes of explanation, method 300 will be described in relation to its performance on micromobility network 100 with a specific focus on treating method 300 as, for example, programming instructions stored on which can be executed on the processor on each universal controller 116.

Block 304 comprises determining the type of micro-mobility and AMU (Autonomous Mobility Unit). Block 308 comprises determining the range of instructions for the identified type of micro-mobility and AMU. Block 312 comprises receiving control instructions from a remote computing device. Block 316 comprises sending the control instructions to the AMU.

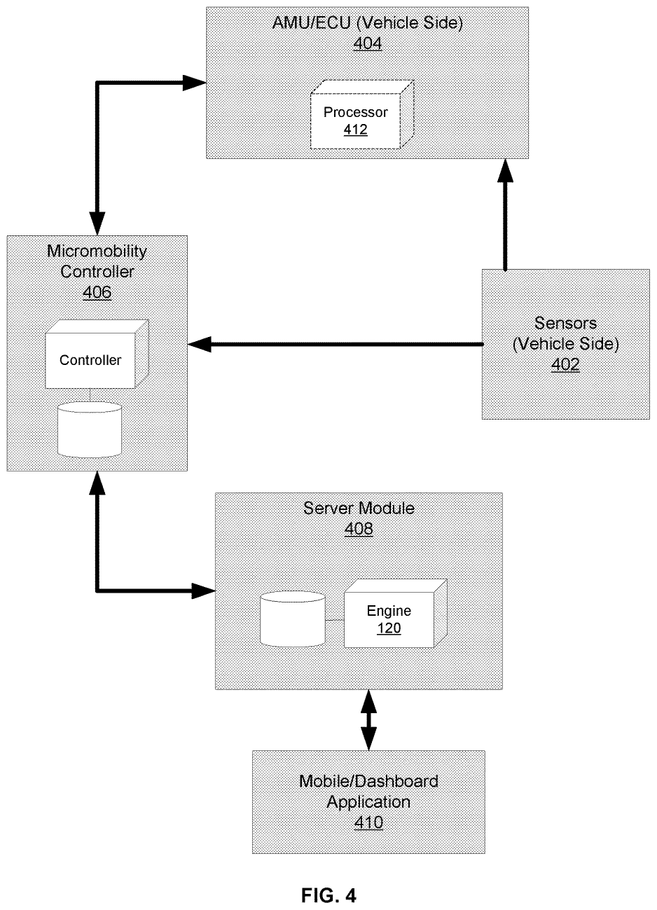

Turning now to FIG. 4, a block diagram of the communication network is provided therein. On each micromobility vehicle, an AMU or ECU 404 is present. The AMU/ECU can be coupled to a plurality of sensors 402 that acquire information about the vehicle. Electric mobility vehicles, such as e-bikes, scooters, and electric cars, are typically equipped with various sensors 402 that can be configured to enhance safety, performance, and user experience. The sensors 402 can include, but are not limited to: temperature sensors, air pressure sensors, speed sensors, RPM sensors, throttle position sensors, cameras, image sensors, or any other sensors that are present on the micromobility vehicle.

For example, speed sensors can be operatively coupled to monitor the rotational speed of the wheels, providing input for motor control and anti-lock braking systems. Throttle position sensors can be configured to detect the user's input on the throttle, enabling precise adjustment of motor power to meet acceleration demands. Pedal cadence sensors, commonly integrated in e-bikes, can be used to measure the rotational rate of the pedals, facilitating the operation of pedal-assist systems that supplement human effort. Additionally, torque sensors can be included to detect the force applied by the rider, enabling dynamic motor assistance proportional to the rider's input. Voltage, current, and temperature sensors can also be included within the battery management system to monitor the state of charge, operational safety, and energy efficiency of the battery. Further, gyroscopes and accelerometers may be configured to monitor tilt, orientation, and stability, enabling additional safety features such as fall detection or automatic balancing. In certain embodiments, proximity sensors, ultrasonic sensors, or cameras may be employed to detect obstacles or assist in collision avoidance. Collectively, the sensors 402 can provide data inputs that enable precise control, optimized energy management, and improved safety in electric mobility vehicles.

The sensors can pass the data to the ECU/AMU 404 which comprises a processor 412. The processor 412 within the Engine Control Unit (ECU) 404 can be configured to execute control algorithms and manage data processing tasks necessary for the operation of various vehicle subsystems. Specifically, the processor can be operatively connected to the plurality of sensors 402 and actuators to receive input signals and transmit control commands. For example, the processor may execute instructions to process data from sensors, such as speed, torque, or temperature sensors, and determine corresponding control actions, such as adjusting motor power, regulating fuel injection, or modulating braking force. Additionally, the processor may perform real-time computations to implement closed-loop feedback control systems, ensuring precise and adaptive operation of critical systems, such as powertrain management or advanced driver-assistance systems (ADAS). In certain embodiments, the processor is configured to execute diagnostic functions by analyzing sensor data to detect faults or anomalies, thereby enhancing system reliability. Furthermore, the processor may facilitate communication with other electronic control units (ECUs) via in-vehicle networks, such as: Controller Area Network (CAN), Asynchronous serial communication via a universal asynchronous receiver-transmitter (UART), or Automotive Ethernet, to enable coordinated operation across multiple vehicle subsystems.

The processor 412 can be connected to the micromobility controller 406 to communicate with external devices or cloud-based systems to support over-the-air updates or telematics functionalities. Through these capabilities, the processor 412 can serve as the central control element within the ECU, ensuring efficient, reliable, and adaptive vehicle operation. The micromobility controller 406 can communicate with the ECU/AMU 404 to transmit the signals from the ECU/AMU 404 to an external server module 408. The server module 408 can include the engine 120. The server module 408 can also connect to a mobile application or dashboard application 410, allowing the user to gain control of the micromobility vehicle.

The controller can be physically connected to various vehicles to enable advanced communication and control functionalities. It includes an Application Programming Interface (API) to facilitate software integration, allowing interaction with third-party applications and systems. The device's form factor is not particularly limited, making it adaptable for integration into different vehicle types and configurations.

The controller comprises several components that enhance its functionality. It incorporates a Bluetooth Low Energy (BLE) chip from Nordic, supporting both BLE and Near Field Communication (NFC) for efficient short-range wireless communication. A 7600 GA global communication module is included to enable reliable connectivity across multiple regions. The microcontroller is selected from the NOTON M031 series, with compatible options such as Nuvoton M031 or M032, STM-32, or Microchip PIC AVR, providing robust processing power. A dedicated antenna is included for GPS functionality, ensuring accurate location tracking and geofencing capabilities. The controller is equipped with an independent power supply system for reliable operation and features a Type-C connection to facilitate serial communication with vehicles. An EPROM with an 8 MB capacity provides sufficient storage for system data, and a SIM card slot is available for cellular communication.

For vehicles with unique communication protocols or those lacking inherent controllers, a secondary board can be provided. This board can mimic the functions of a controller or act as a simple switch, ensuring compatibility with a wide range of vehicle types, including “dumb” vehicles. The controller is compatible with vehicles that utilize serial communication, Controller Area Network (CAN), or other communication systems, and employs TCP for server communication. It also provides third-party access to IoT capabilities via a REST API, allowing seamless integration with other systems.

The controller is designed for integration with Original Equipment Manufacturers (OEMs) that use specific vehicle protocols. It is capable of locking and unlocking vehicles based on communication types, such as serial or CAN protocols. The controller device is particularly suited for shared mobility applications, such as rental fleets, where features like offline geofencing and a keyless user experience improve convenience and efficiency. NFC integration can also be used to facilitate efficient payment processes, while safety and compliance features, including driver verification, age restriction enforcement, and alcohol consumption checks, ensure adherence to regulations.

The controller is operatively connected to the vehicle's Engine Control Unit (ECU), which communicates with the main controller or the BLE module to collect critical information such as temperature, tire pressure, battery percentage, speed, acceleration, and RPM. This information is transmitted to the IoT controller via CAN, serial, or BLE communication in real-time, periodically through pulse commands, or event-based, such as in the case of a tire puncture, where the data is sent immediately to the server. Additionally, action messages, such as commands to unlock or slow down the vehicle, can be generated and transmitted.

The controller device 406 can also process input from other components, such as NFC modules, and relay data to the server. Vehicles equipped with cameras can process images for geofencing purposes, while a display screen and other sensors may connect to the IoT controller to send visual or sensor data to the server. This enables advanced features such as optimized path suggestions from the server, which can be provided to the vehicle in advance, for instance, at the start of a day.

Error codes from the vehicle can be transmitted to the server via the IoT controller, allowing remote diagnostics and restart commands. The controller is further configured to execute multiple algorithms, such as a Vehicle-Fall Algorithm or an Offline Geofencing Algorithm, where the algorithm's output may trigger commands sent to the ECU from either the server or the controller itself.

The BLE module can utilize components such as ESP32, RFBM-ND08, or TIWI, providing flexibility in hardware selection. The GSM module may employ components like the SIMCOM A 7672G or similar, supporting cellular communication over 4G, 5G, or other networks. The GSM module can be configured as a global module for worldwide deployment or as a regional GSM module for localized applications. The GPS module, which may be a SIM68D or similar, supports L1 and L5 bands for precise location tracking, ensuring compatibility with advanced geolocation systems.

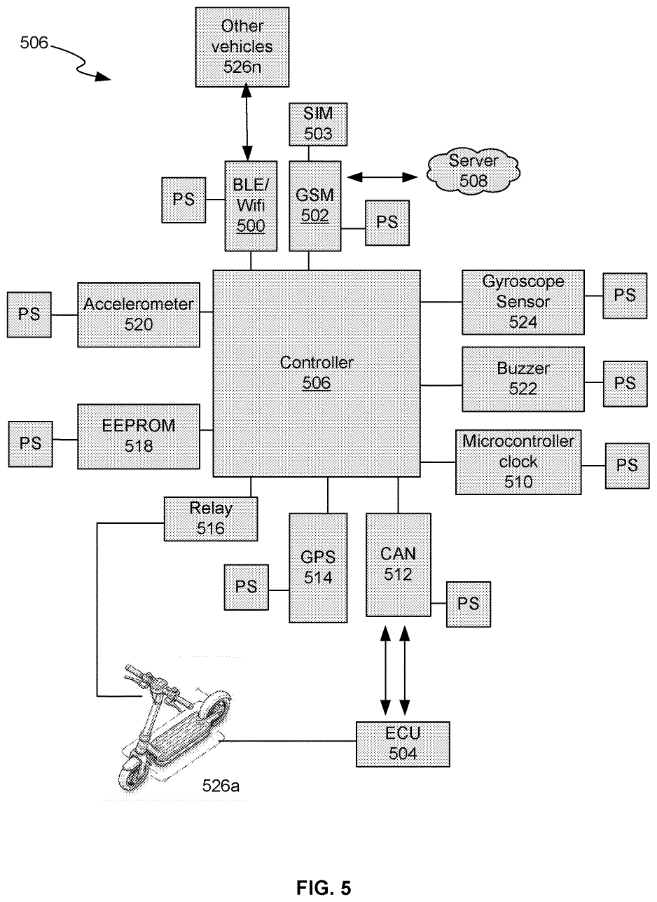

FIG. 5 illustrates a block diagram of the micromobility controller 506. The micromobility controller 506 can be connected to at least any one, or any combination of the following: a BLE/Wi-Fi module 500, a GSM (Global System for Mobile Communications) module 502, a CAN communication module 512, a GPS (global positioning system) module 514, a relay switch 516, a memory 518, an accelerometer 520, a gyroscope sensor 524, a buzzer 522, and a microcontroller clock 510. Each of these components can be connected to the controller 506. Additionally, each of the components can be connected to a power supply or batter, indicated with PS.

The BLE/Wi-Fi module 500 is configured to enable wireless communication between the micromobility controller 506 and external devices or systems. This module may use Bluetooth Low Energy (BLE) for short-range communication, such as pairing with other vehicles 526n for real-time monitoring, configuration, or diagnostics. The Wi-Fi functionality allows for medium-range connectivity to local networks, facilitating firmware updates, remote control, or integration with Internet of Things (IoT) platforms. Through these wireless protocols, the BLE/Wi-Fi module 500 can enable data exchange and system integration.

The GSM module 502 can be used to provide cellular connectivity, allowing the micromobility vehicle to transmit data over long distances to a server 508, via a SIM card 503. The GSM module may be used for applications such as telematics, real-time vehicle tracking, or emergency alert systems. Using the GSM module 502, the vehicle 526a can communicate with cloud servers 508, enabling fleet operators to monitor usage, location, and performance metrics remotely. Additionally, GSM connectivity can support security features such as geofencing or remote immobilization in case of theft.

The CAN communication module 512 is operatively connected to facilitate communication between the micromobility controller 506 and other electronic control units (ECUs) or subsystems within the vehicle. The Controller Area Network (CAN) protocol is a robust, real-time communication standard used to exchange data between vehicle components, such as motor controllers, battery management systems, and braking systems. This module ensures the efficient and reliable transfer of control commands and sensor data, supporting the coordinated operation of the vehicle's various systems.

The GPS module 514 can be included to allow the micromobility vehicle 526a to determine its precise location using satellite-based navigation. This module can be used for applications such as navigation assistance, geofencing, and real-time tracking. For instance, in shared micromobility systems, the GPS module 514 allows operators and users to locate vehicles via mobile applications. Furthermore, GPS data can be used to optimize route planning and improve fleet management efficiency.

The relay switch 516 serves as an electronic or electromechanical switch controlled by the micromobility controller 506 to enable or disable the flow of electrical current to specific components. The relay 516 can be used to control power delivery to the entire vehicle 526a, acting as a security shut-off switch, or can be used to control power delivery to sub-systems such as lights, motors, or auxiliary devices, allowing the controller to conserve energy or respond to user commands. For example, the relay switch 516 may be used to activate a headlamp or disable the vehicle motor in response to a system fault or security command.

The memory 518 can be used to store data and instructions necessary for the operation of the micromobility vehicle 518. The memory component may include volatile memory, such as RAM, for temporary data storage during operation, and non-volatile memory, such as flash storage, for retaining firmware, system logs, and user preferences. In the embodiment shown in FIG. 5, the memory component 518 is an EEPROM (Electrically Erasable Programmable Read-Only Memory). The memory 518 allows the controller 506 to execute algorithms, store telemetry data, and update system functionalities through over-the-air firmware updates.

The accelerometer 520 can be included to measure linear acceleration along one or more axes. This sensor can detect changes in the vehicle's velocity or orientation, providing critical data for safety and performance features. For example, the accelerometer 520 may be used to detect sudden braking, impact events, or changes in terrain, allowing the controller 506 to adjust motor output or issue alerts to the user.

The gyroscope sensor 524 can be included to measure rotational velocity and angular position, enabling the micromobility controller 506 to determine the vehicle's orientation and stability. This sensor can be used for advanced safety features, such as tilt detection, roll prevention, or self-balancing systems. When combined with the accelerometer 520, the gyroscope sensor 524 allows the controller to execute precise motion tracking and control.

The buzzer 522 can be included to serve as an audio output device, typically used to emit sound alerts or notifications. The micromobility controller 506 can activate the buzzer 522 in response to specific conditions, such as low battery warnings, system errors, or theft alerts. This component enhances the vehicle's ability to communicate status or warnings to the user.

The microcontroller clock 510 can be used to provide a stable timing reference for the micromobility controller 506, enabling accurate execution of control algorithms and communication protocols. The clock ensures that system processes, such as sensor data acquisition, motor control, and wireless communication, occur with precise timing, enhancing the overall reliability and performance of the vehicle.

Each of these components can be connected to a power supply or battery, designated as PS. The power supply can be configured to deliver appropriate voltage and current levels to each component based on its operational requirements.

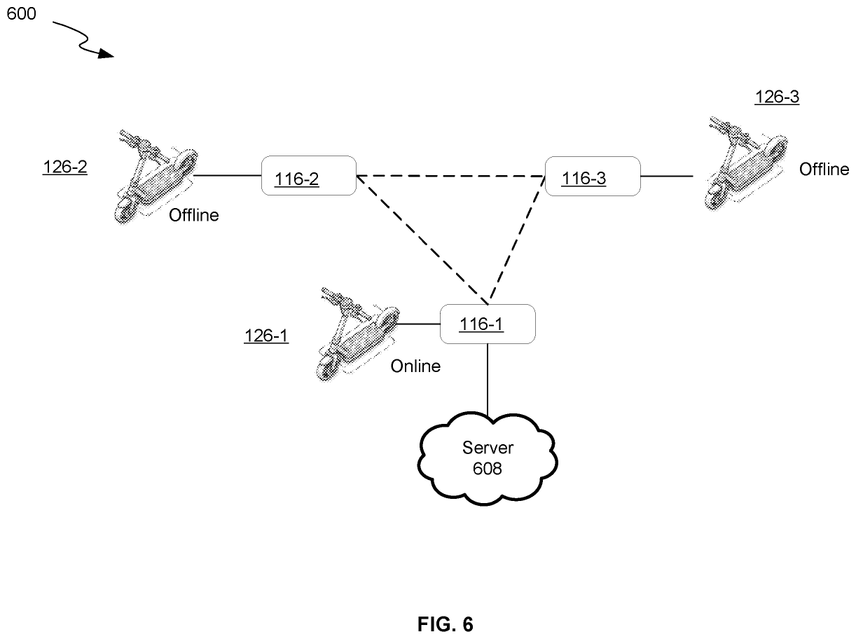

Turning now to FIG. 6, which illustrates a schematic diagram of the Bluetooth connectivity feature 600 across a plurality of micromobility assets comprising Vehicle 1 (126-1), Vehicle 2 (126-2), and Vehicle 3 (126-3). Each of the vehicles is connected to a respective micromobility controller 116-1, 116-2, and 116-3. Two of the vehicles, 126-2 and 126-3 are offline, meaning their respective controllers 116-2 and 116-3 are not connected to the server. One of the vehicles, 126-1, and its respective controller 116-1, is online and connected to the server 608. Using the BLE module inside each of the controllers, each of the offline controllers can facilitate communication with the online controller, and gain access to the server.

As such, each of the controllers can maintain continuous communication with each of the plurality of vehicles by transmitting data via Bluetooth connectivity, even if one or more of the vehicles is offline (i.e. not connected to the server). Bluetooth is a wireless communication protocol that enables the creation of large-scale networks consisting of thousands of devices. Unlike traditional point-to-point and star network topologies, Bluetooth can be used to form a mesh network where each device (node) can communicate with every other device in the network, allowing for increased coverage and reliability. As these vehicles traverse different locations, they share pertinent information through various protocols, including speed, acceleration, and precise location coordinates such as latitude and longitude, with a centralized server. The vehicle will transmit the broadcasted message in encrypted form. Upon reception, other passing vehicles within the plurality of vehicles will decrypt the message to ascertain its content. Subsequently, the controllers can encrypt the data again before transmitting it to the server. In some embodiments, the BLE connection can occur when at least one controller is proximal to another controller. Each of these controllers can be offline or online. However, at least one controller in the network of controllers is online to facilitate communication with the server. In one embodiment, proximal may refer to two controllers that are within typical Bluetooth communication range, or between about 0 and about 100 meters. In some embodiments, the communication range can be about 0 to about 500 meters.

Data including speed data, acceleration data, precise location coordinates, latitude, longitude can be shared using the centralized server. The vehicle transmitting the broadcasted message can do so in an encrypted form. Upon reception, other passing vehicles within the network of vehicles can decrypt the message to ascertain its content.

The communication network can facilitate several crucial scenarios. In at least one embodiment, in the event of an accident, the involved vehicle broadcasts an alert to the server and nearby vehicles. This proactive dissemination of information allows passing vehicles to adjust their speed accordingly, enhancing safety on the road. Vehicles can rely on offline connectivity methods such as Bluetooth, to continuously broadcast their status. Passing vehicles receive these broadcasts, enabling them to update the server with real-time data, ensuring accurate monitoring and management despite temporary network constraints. A vehicle in distress can broadcast a distress signal to nearby vehicles. This transmission prompts passing vehicles to relay the information to the server, facilitating prompt action to address the distress scenario.

In at least one embodiment, vehicles within parking areas lacking internet connectivity can leverage Bluetooth connectivity to continuously broadcast their status. Passing vehicles receive these broadcasts, enabling them to update the server with real-time data, ensuring accurate monitoring and management despite temporary network constraints.

In at least one embodiment, should a vehicle experience low battery levels, it can utilize Bluetooth Low Energy (BLE) connectivity to broadcast a distress signal to nearby vehicles. This transmission prompts passing vehicles to relay the information to the server 608, facilitating prompt action to address the low battery scenario. In one embodiment, this can include shutting off, or reducing the speed of the vehicle via the ECU or the relay switch.

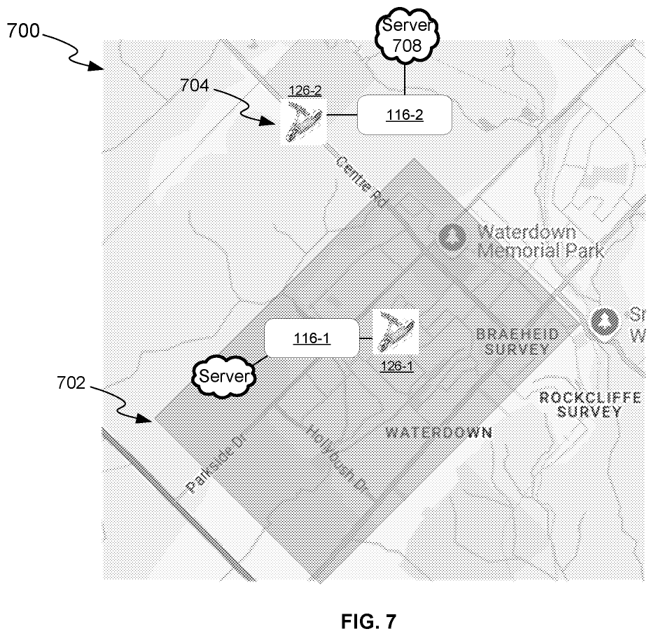

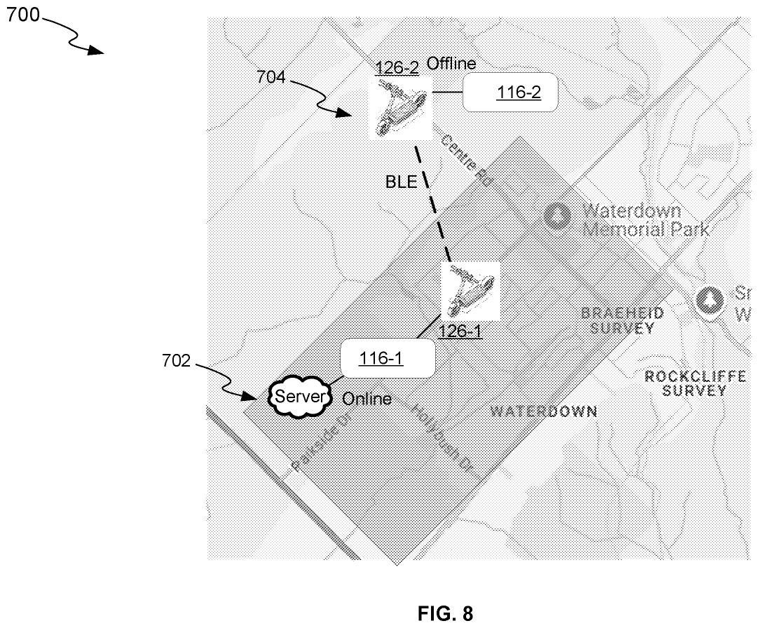

FIGS. 7 and 8 illustrate examples of the geofencing application. In this embodiment, a map 700 is used to virtually represent a real world location. Boundaries 702 can be defined which provide permissible areas for the micromobility vehicle to roam. Additional boundaries 704 can be defined that provide prohibited areas for the vehicle. These boundaries can be determined by the vehicle operators, or the fleet operators, or other authorities such as police, hospitals, law makers etc. In at least one embodiment, a GPS (Global Positioning System), RFID (Radio-Frequency Identification), Wi-Fi, or cellular data systems can be used to define the boundaries in the real world. These boundaries, often called geofences, can trigger predefined actions or alerts when a device or object enters or exits the designated area.

A GPS module can be provided in the controller 116 to track the precise location of the micromobility vehicle 126 at all times using satellite-based navigation. For vehicles 126-1 within the allowable boundary 702, the controller 116-1 can maintain communication with the server to ensure that the vehicle remains within the acceptable boundary 702. When the vehicle 126-2 exits the permissible boundary 702, a command can be sent from the server 708 to the ECU of the vehicle to actuate the brakes or perform another action. In some cases, the brakes may be completely actuated to bring the vehicle to a complete stop. In other cases, the brakes may be partially actuated to slow the vehicle down. The geographical boundaries can also be applied to special zones, such a school zones, high traffic zones, parks, etc. to cause the micromobility vehicles to automatically reduce their speed when they enter these zones. Furthermore, the geofencing application can also be used to manage golf carts within a golf course; or electric shopping carts in a shopping center; etc.

Turning to FIG. 8, if one of the vehicles loses communication with the server and becomes offline, the BLE module within the control 116-2 can communicate with the BLE module within an online controller 116-1 to restore the connection with the server. In some embodiments, the BLE connection can occur when at least one controller is proximal to another controller. Each of these controllers can be offline or online. However, at least one controller in the network of controllers is online to facilitate communication with the server to enable offline geofencing. In one embodiment, proximal may refer to two controllers that are within typical Bluetooth communication range, or between about 0 and about 100 meters. In some embodiments, the communication range can be about 0 to about 500 meters.

In view of the above it will now be apparent that variants, combinations, and subsets of the foregoing embodiments are contemplated.

A person skilled in the art will now appreciate that the teachings herein can provide certain advantages over the prior art. For example, the present invention's universality and versatility enable it to control a variety of micro-mobilities, which can be especially useful for entities or individuals that use or own multiple types of micro-mobilities, thereby reducing the need for multiple controllers. Ease of installation is facilitated by the design, which includes a mount for seamless attachment to micro-mobility frames, allowing users to effortlessly switch between different vehicles. Furthermore, the device's ability to promptly identify the type of micro-mobility and its associated AMU streamlines the setup process, decreasing the likelihood of user errors and ensuring a more efficient initialization. The inclusion of a secondary communication interface in the device broadens its capabilities, enabling remote communication with computing devices operated by users. This innovative feature not only permits remote control but also provides avenues for diagnostics and monitoring of the micro-mobility, potentially enhancing fleet management or emergency response scenarios. Precision in the control of micro-mobilities is emphasized as the device can establish a tailored range of instructions specific to the detected AMU. This ensures that operations remain within the micro-mobility's intended parameters, effectively minimizing operational errors. The universal controller an accommodate potential software updates, thereby maintaining its relevance with the ever-evolving micro-mobility landscape. Standardization, a key advantage, becomes feasible especially for organizations that manage diverse micro-mobilities. Such standardization simplifies training processes, maintenance routines, and inventory management. From an economic standpoint, this universal approach might also offer more efficiency compared to managing individual controllers for each micro-mobility type. Safety, an imperative in design, is bolstered by the device's capability to dispatch apt control instructions congruent with the specific micro-mobility type. Overall, the use of micro-mobilities is encouraged which can also help reduce carbon emissions as micro-mobilities are used over other more carbon intensive vehicles. Further advantages may be considered when used in tandem with other systems. Its communication capabilities, when synergized with complementary technologies, open the possibility of data collection on micro-mobility usage patterns and performance. Such amassed data holds promise for detailed analysis, research, and optimization, offering a comprehensive view of micro-mobility dynamics. In essence, the functionalities embedded within this invention provide a multifaceted advantage in the micro-mobility controller domain, harmonizing versatility, safety, and technological integration.

It should be recognized that features and aspects of the various examples provided above can be combined into further examples that also fall within the scope of the present disclosure. In addition, the figures are not to scale and may have size and shape exaggerated for illustrative purposes.

1. A controller device for controlling a plurality of micromobility vehicles comprising:
a chassis with a mount for attachment to a frame of at least one micromobility vehicle of the plurality of micromobility vehicles;
a board assembly within the chassis having:
a memory for storing programming instructions;
a processor in communication with the memory for executing the programming instructions;
a first communication interface connected to the processor, and for connection to an activation and management unit (AMU) of each of the plurality of micromobility vehicles;
a second communication interface connected to the processor for communication with a remote computing device;
the programming instructions for configuring the processor to:
(a) determine a type of the plurality of micromobility vehicles and associated AMU;
(b) based on the type, establish a range of instructions to the associated AMU for controlling the at least one micromobility vehicle;
(c) receive a control instruction from within the range of instructions from the remote computing device; and,
(d) send the control instruction to the AMU to cause the at least one micromobility vehicle to operate according to the instruction according to the type of the micromobility vehicle;
wherein the controller maintains continuous communication with each of the plurality of vehicles by transmitting data to and from each of the plurality of vehicles.

2. The controller device of claim 1, further comprising at least one sensor connected to the plurality of micromobility vehicles for acquiring and transmitting data about the micromobility vehicle to the remote computing device; and wherein the data is at least one of: speed data, acceleration data, and location data.

3. The controller device of claim 2, wherein at least one of the plurality of vehicles can transmit a broadcasted message to the remote computing device in an encrypted form.

4. The controller device of claim 3, wherein at least another of the controllers of the plurality of vehicles decrypts the message to ascertain the broadcasted message.

5. The controller device of claim 1, wherein the remote computing device includes a positioning module for determining a location of the micromobility vehicle; and the programming instructions for further configuring the processor to:
send an override control instruction to the AMU to cease movement of the micro-mobility if the location of the micromobility vehicle is outside of a geofenced area.

6. The controller device of claim 5, wherein the remote computing device maintains a virtual map of the geo-fenced area.

7. The controller device of claim 1, wherein the remote computing device is configured to execute an application that can receive control instructions for a plurality of types of micromobility vehicles.

8. The controller device of claim 3, wherein the application is configured to authenticate with at least one micro-mobility fleet management engine that is respective to different micro-mobilities of the same or different types; and the application being further configured to accept control instructions for a given micro-mobility after authentication.

9. The controller device of claim 1, wherein the plurality of vehicles maintain continuous communication with each other by transmitting offline data over a Bluetooth low energy communication protocol; and wherein at least one of the plurality of vehicles is connected to the remote computing device such that the offline data from the plurality of vehicles is continuously received by the remote computing device via the controller device of the at least one of the plurality of vehicles.

10. A method of controlling a plurality of micromobility vehicles using a controller, the controller comprising:
a chassis having a mount for attachment to a frame of a micro-mobility;
a board assembly within the chassis having:
a memory for storing programming instructions;
a processor in communication with the memory for executing the programming instructions;
a first communication interface connected to the processor and for connection to an activation and management unit (AMU) of the micro-mobility;
a second communication interface connected to the processor for communication with a remote computing device;
the method comprising:
a) determining a type of the micro-mobility and associated AMU;
b) based on the type, establishing a range of instructions to the associated AMU for controlling the micro-mobility;
c) receiving a control instruction from within the range of instructions from the remote computing device; and,
d) sending the control instruction to the AMU to cause the micro-mobility to operate according to the instruction according to the type of the micro-mobility.

11. The method of claim 10, further comprising acquiring and transmitting data from at least one sensor connected to the plurality of micromobility vehicles; and sending the data to the remote computing device; and wherein the data is at least one of: speed data, acceleration data, and location data.

12. The method of claim 11, further comprising transmitting, via the controller device, a broadcasted message to the remote computing device in an encrypted form.

13. The method of claim 12, further comprising decrypting, via at least another of the controllers of the plurality of vehicles, to ascertain the broadcasted message.

14. The method of claim 10, further comprising determining a location of the micromobility vehicle using a positioning module; and further configuring the processor to:
send an override control instruction to the AMU to cease movement of the micro-mobility if the location of the micromobility vehicle is outside of a geofenced area.

15. The method of claim 14, further comprising maintaining a virtual map of the geo-fenced area on the remote computing device.

16. The method of claim 10, wherein the remote computing device is configured to execute an application that can receive control instructions for a plurality of types of micromobility vehicles.

17. The method of claim 10, wherein the application is configured to authenticate with at least one micro-mobility fleet management engine that is respective to different micro-mobilities of the same or different types; and the application being further configured to accept control instructions for a given micro-mobility after authentication.

18. The method of claim 10, further comprising maintaining continuous communication between the plurality of vehicles by transmitting offline data over a Bluetooth low energy communication protocol; and wherein at least one of the plurality of vehicles is connected to the remote computing device such that the offline data from the plurality of vehicles is continuously received by the remote computing device via the controller device of the at least one of the plurality of vehicles.
